(19) United States
(12) Patent Application Publication
(10) Pub. No.: US 2015/0117796 A1
(43) Pub. Date: Apr. 30, 2015

(54) METHOD AND SYSTEM FOR PRIORITIZING POINTS OF INTEREST FOR DISPLAY IN A MAP

(71) Applicants: Harlan Gerhardt Hile, Seattle, WA (US); Nicholas John Lee, Bothell, WA (US)

(72) Inventors: Harlan Gerhardt Hile, Seattle, WA (US); Nicholas John Lee, Bothell, WA (US)

(73) Assignee: Google Inc., Mountain View, CA (US)

(21) Appl. No.: 13/412,511

(22) Filed: Mar. 5, 2012

Related U.S. Application Data
(60) Provisional application No. 61/468,559, filed on Mar. 28, 2011.

(51) Int. Cl. G01C 21/36; G06F 17/30

(52) U.S. Cl. CPC G01C 21/3679; G06F 17/30247
USPC 382/305; 707/748; 707/758; 707/E17.039; 707/E17.018

(57) ABSTRACT

Systems, methods, and machine-readable media for prioritizing points of interest for display in a map have been described. In certain aspects a system may include an interface module, a search module, and a priority module. The interface module may be configured to obtain pattern recognition data and location data associated with an image of a geographical area. The search module may be configured to access a set of point of interest listings and determine whether the pattern recognition data and the location data associated with the image correspond with a point of interest listing in the set of point of interest listings. The priority module may be configured to prioritize the point of interest listing for display in a map if a point of interest listing in the set of point of interest listings is determined to correspond.

### RELATED APPLICATION

This application claims priority to U.S. Provisional Patent Application No. 61/468,559, filed on Mar. 28, 2011, entitled “METHOD AND SYSTEM FOR PRIORITIZING POINTS OF INTEREST FOR DISPLAY IN A MAP,” the entire contents of which are herein incorporated by reference in its entirety.

### BACKGROUND

The present disclosure generally relates to the display of information in a user interface.

Maps are often used to help identify points of interest or find directions to a point of interest (POI). For example a map interface may be used by online routing services to help a user visualize a route from one location to another. In another scenario, a user may use online search services to find points of interest near a certain location. These points of interest may be displayed in a map interface to help a user identify or visualize the location of the point of interests.

In some cases, it may be useful to show a number of points of interests on a map. However, in some cases, not all points of interest in a map interface may be effectively shown at the same time.

### SUMMARY

According to one aspect of the subject technology, a system for prioritizing points of interest for display in a map is provided. The system may include an interface module, a search module, and a priority module. The interface module may be configured to obtain pattern recognition data and location data associated with an image of a geographical area. The search module may be configured to access a set of point of interest listings and determine whether the pattern recognition data and the location data associated with the image correspond with a point of interest listing in the set of point of interest listings. The priority module may be configured to prioritize the point of interest listing for display in a map if a point of interest listing in the set of point of interest listings is determined to correspond.

According to another aspect of the subject technology, a computer-implemented method for prioritizing points of interest for display in a map is provided. The method may include obtaining pattern recognition data extracted from an image of a geographical area and location data for the image of the geographical area and searching a database comprising a plurality of point of interest listings for a point of listing that corresponds with the pattern recognition data and the location data. The method may further include prioritizing the point of interest listing for display in a map if the point of interest that corresponds with the pattern recognition data and the location data is found.

According to yet another aspect of the subject technology, a machine-readable medium including instructions stored therein, which when executed by a machine, cause the machine to perform operations for prioritizing points of interest for display in a map is provided. The operations may include obtaining pattern recognition data and location data associated with an image of a geographical area and accessing a set of point of interest listings, wherein each point of interest listing in the set of point of interest listings comprises a ranking value. The operations may further include searching the set of point of interest listings for a point of interest listing that corresponds with the pattern recognition data and the location data associated with the image and modifying the ranking value of the corresponding point of interest listing if a corresponding point of interest listing is found.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed aspects and together with the description serve to explain the principles of the disclosed aspects.

FIG. 1 is a conceptual diagram illustrating a network environment for prioritizing points of interest for display in a map, in accordance with one aspect of the subject technology.

FIG. 2 is a user interface illustrating a map including a number of points of interest, in accordance with one aspect of the subject technology.

FIG. 3 is a conceptual block diagram illustrating a mapping system configured to prioritize points of interest for display in a map using pattern recognition data extracted from an image, in accordance with various aspects of the subject technology.

FIG. 4 is a flow chart illustrating a process for prioritizing points of interest for display in a map, in accordance with various aspects of the subject technology.

FIG. 5 is a flow chart illustrating a process for generating a map of an area that includes points of interest, in accordance with one of the subject technology.

FIG. 6 is a conceptual block diagram illustrating a computer system with which each of the clients and servers of FIG. 1 may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

Many factors or signals may be used to prioritize points of interest for display in a map. For example, the location of a point of interest, the distance of the point of interest to a reference location (e.g., a user's location), the type of point of interest (e.g., a place of business, a government office, a retail outlet, a landmark, etc.), review ratings, and the web presence of the point of interest may all be considered in prioritizing a point of interest. It may also be helpful to take into account the data extracted from images associated with a point of interest.

In accordance with various aspects of the subject technology, systems and methods for prioritizing points of interest for display in a map using pattern recognition data extracted from an image are disclosed. By prioritizing points of interest to be displayed on a map, a mapping system may display the most useful points of interest while hiding other points of interest from view. As a result, the map may be less cluttered, more readable, and more useful to a user.

In one scenario, a listing service may gather information associated with points of interest (e.g., the location of a point of interest) from various sources on the Internet. For each point of interest, the information gathered about that point of interest may be stored as a point of interest listing in a database. The listing service may also provide information about points of interest to various services. However, information gathered from the Internet may not always be correct or up-to-date. For example, a business associated with a location may have incorrectly listed their location, closed at that location, or moved to another location without updating their website or online directory listing.

In accordance with one aspect of the subject technology, a system may be configured to verify the location of a point of interest by extracting pattern recognition data from an image of the location where the system expects the point of interest to be and looking for indications of the physical presence of the point of interest (e.g., presence of a storefront or store sign) in the pattern recognition data. The location of the point of interest may be verified if a physical presence is found.

Those points of interest whose locations have been verified may be more reliable and useful than those points of interest who do not have verified locations. Accordingly, when determining which points of interest to display in a mapping interface, the system may be configured to prioritize points of interest that have been verified over points of interest that have not been verified.

In another scenario, a routing service may be configured to generate a route for a user from one location to another. The routing service may display the route, along with points of interest along the route that are useful for navigation, to a user in a mapping interface. Accordingly, points of interest that are more visible or more easily identifiable from a road or trail (e.g., a large, unobstructed public storefront or signage) may be more useful for navigating than those that are not (e.g., a public storefront or signage that is difficult to see or non-existent).

According to another aspect, the visibility of a point of interest (e.g., the size or visibility of a storefront or store sign associated with the point of interest) may be considered when prioritizing points of interest to be displayed to a user in a mapping interface. For example, a mapping system may be configured to extract pattern recognition data from an image of the area near the location of the point of interest, identify indications of the physical presence of the point of interest (e.g., a storefront or store sign), and calculate a visibility score for the point of interest based on the indications. The point of interest may then be prioritized with respect to other points of interest in an area to be displayed based on the visibility score.

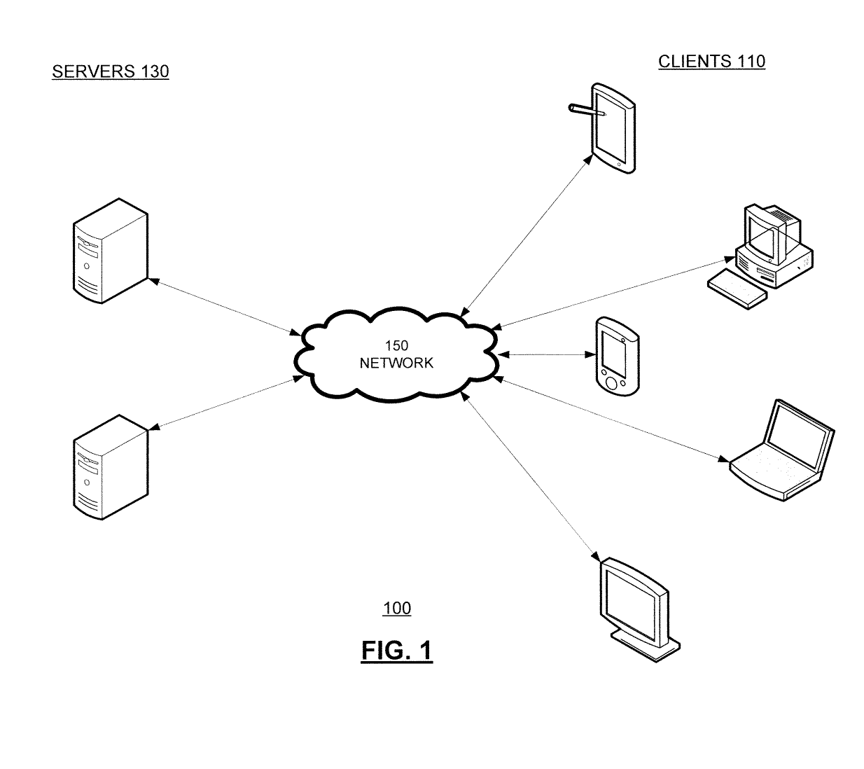

FIG. 1 is a block diagram illustrating a network environment 100 in which points of interest may be prioritized for display in a map, in accordance with one aspect of the subject technology. The architecture includes servers 130 and clients 110 connected over a network 150. Although FIG. 1 illustrates a client-server network environment 100, other aspects of the subject technology may include other configurations including, for example, peer-to-peer environments or single system environments.

The servers 130 may be any system or device having a processor, a memory, and communications capability for prioritizing points of interests for display in a mapping interface. The servers 130 may provide various services. For example, the servers may host a local search service which may be used to search for points of interests in a given area or a routing service which may be used to find directions from a starting location to the location of a point of interest.

The servers 130 may also include a mapping system configured to generate a mapping interface for the local search service or the routing service. The maps may be transmitted over the network 150 to one or more clients 110 to be displayed in a mapping interface. Each map generated by the mapping system may include points of interest that are located in the area represented by the map. Because showing all points of interest located in the area represented by the map may clutter the map, the mapping system may be configured to prioritize which points of interest may be most useful to a user viewing the map and include only a subset of all of the points of interest located in the area represented by the map based on the prioritization of the points of interest.

The clients 110 to which the servers 130 are connected over the network 150 may be, for example, desktop computers, mobile computers, tablet computers, mobile devices (e.g., a smart phone or a global positioning system (GPS) device), set top boxes (e.g., for a television), video game consoles, thin clients, or any other devices having appropriate processor, memory, and communications capabilities. The clients 110 may be configured to run applications (e.g., a GPS program, a web browser, etc.) with user interfaces that can display a map including various points of interest to a user.

The network 150 may include, for example, any one or more of a personal area network (PAN), a local area network (LAN), a campus area network (CAN), a metropolitan area network (MAN), a wide area network (WAN), a broadband network (BBN), the Internet, and the like. Further, the network 150 may include, but is not limited to, any one or more of the following network topologies, including a bus network, a star network, a ring network, a mesh network, a star-bus network, tree or hierarchical network, and the like.

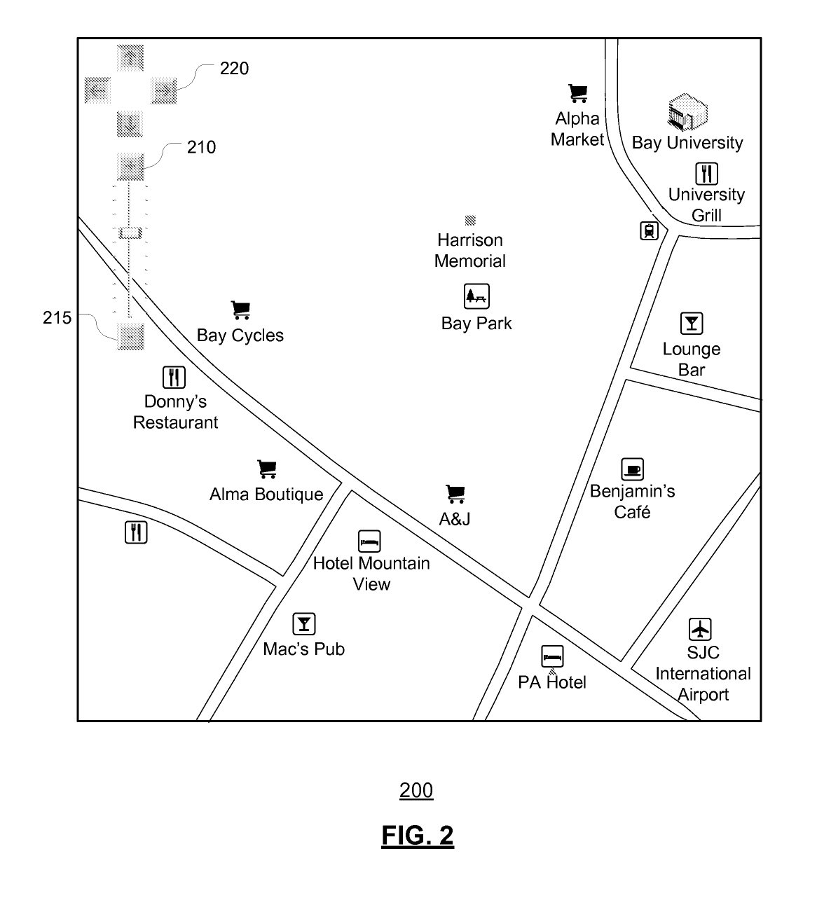

FIG. 2 is a user interface 200 illustrating a map (e.g., a mapping interface) including a number of points of interest, in accordance with one aspect of the subject technology. The map in the user interface 200 may be generated by the mapping system discussed with respect to FIG. 1 and may contain a variety of points of interest. For example the points of interest displayed in the mapped area may include businesses (e.g., retail stores, hotels, restaurants, etc.), government buildings, landmarks, churches, hospitals, neighborhoods, parks, airports, districts, or any other type of location. Each point of interest may be identified on the map using an icon, a label, or both.

Each point of interest displayed on the mapped area may correspond to a point of interest listing stored in a database. The point of interest listing may contain information about the point of interest such as the point of interest name, address, location coordinates, phone number, website, the type of the point of interest, associated categories or terms, or any other information associated with a point of interest.

The user interface 200 may also include controls (e.g., zoom-in control 210, zoom-out control 215, and scroll control 220) that enable a user on a client device 110 to control a zoom level of the map or to scroll the map in one or more directions. When a user activates one or more controls on the user interface 200, the mapping system may update the map and the points of interest to be displayed on the map. For example, if a user activates a scroll control 220, the map may scroll in a direction to reveal newly displayed portions of the map and new points of interest may be displayed for the entire map or just for the newly displayed portions of the map.

If a user activates a zoom-in control 210, the area displayed in the map may be viewed from a closer perspective and, according to some aspects, new points of interest, previously not shown may be displayed on the map. If, on the other hand, a user activates a zoom-out control 215, the area displayed in the map may viewed from a wider angle revealing newly displayed portions of the map. Furthermore, according to some aspects, points of interest previously shown may become hidden and new points of interest may be displayed on the newly displayed portions of the map.

Although a number of points of interest are shown in interface 200, many others may be located in the area shown in the map but hidden from view. The mapping system may determine which points of interest are shown on the map based on various factors such as, but not limited to, the zoom level, the number of points of interest located within the area shown in the map, the number of points of interest located within a portion of the area shown in the map (e.g., how densely populated with points of interest a portion of the area shown in the map is), a category associated with each point of interest, attributes of each point of interest, user profile information, search query data, and pattern recognition data extracted from an image associated with a point of interest.

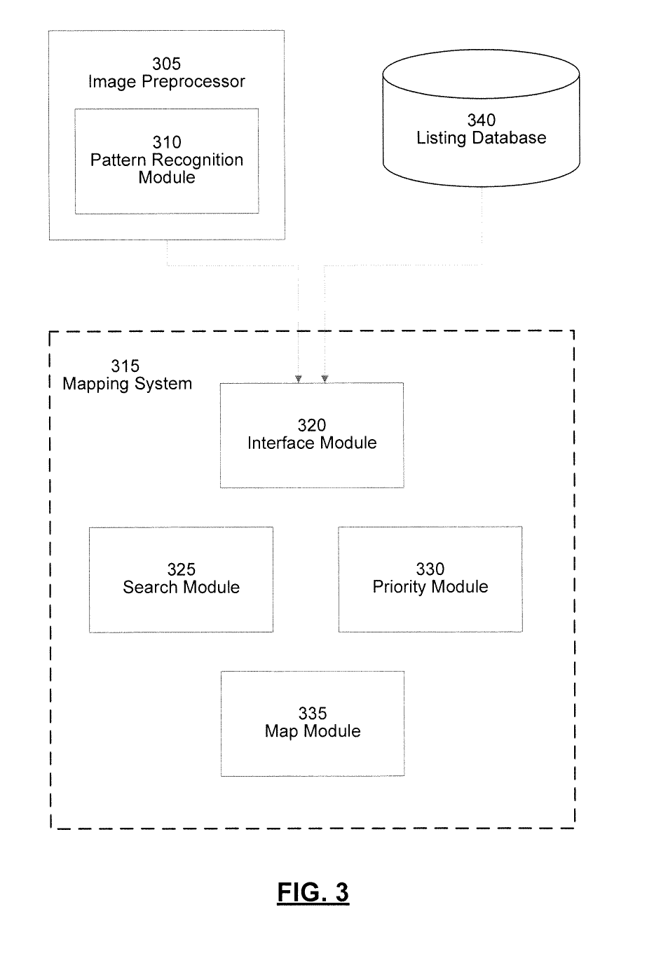

FIG. 3 is a conceptual block diagram illustrating a mapping system 315 configured to prioritize points of interest for display in a map using pattern recognition data extracted from an image, in accordance with various aspects of the subject technology. The mapping system may include an interface module 320, a search module 325, a priority module 330, and a map module 335.

FIG. 3 further shows an image preprocessor 305, a pattern recognition module 310, and a listing database 340. Although the image preprocessor 305, the pattern recognition module 310, and the listing database 340 in FIG. 3 are not shown as being a part of the mapping system 315, in other embodiments, they may be included as part of the mapping system 315.

The listing database 340 may store a number of point of interest listings known to the mapping system 315. Each point of interest listing in the database may include fields for the name of the point of interest, the location of the point of interest, address, phone number, one or more categories or types the point of interest belongs to, tags associated with the point of interest, a web presence value for the point of interest, and other data associated with the point of interest.

As will be discussed in more detail below, according to one aspect of the subject technology, each of the point of interest listings in the listing database 340 may also include one or more ranking values that may be used to determine which point of interest listings will be displayed on a map. The ranking value may be calculated based on factors such as the location of a point of interest, the area to be displayed on the map, the distance of the point of interest to a reference location, the type of point of interest (e.g., a place business, a government office, a retail outlet, a landmark, business category, etc.), review ratings, the web presence of the point of interest, or other characteristics of the point of interest.

The image preprocessor 305 may be configured to receive, from one or more image sources, a number of images that may be used by the mapping system 315 to prioritize points of interest to be displayed in a map. Any image source (e.g., a smart phone, a camera, etc.) may be used. For example, according to one aspect, an image source may include a specialized vehicle that travels various navigable paths of multiple geographical areas and generates one or more images of each geographical area. These images may be transmitted via a network to the image preprocessor 305 in batches or continuously as the images are generated. Image sources may also include user submitted images, images on the Internet, or locally stored images. According to other aspects, the images may be transmitted to the image preprocessor 305 using other means, such as, for example, physical transmission (e.g., storing images on a hard drive or other memory device, transporting the hard drive, and connecting the hard drive to the image preprocessor 305).

In one aspect, each image received by the image preprocessor 305 may be associated with location data (e.g., location coordinates) for the location that the image was taken or the location of a geographical area shown in the image. For example, an image source may contain location determination components such as a global positioning system (GPS) device that may be configured to calculate location data (e.g., GPS coordinates) for a location where the image was taken. The image source may transmit the location data to the image preprocessor 305 along with the image. The location data may be transmitted as a separate data unit or the image source may annotate the image with the location data before transmitting the annotated image to the image preprocessor 305.

Once the images and accompanying location data are received at the image preprocessor 305, a pattern recognition module 310 of the image preprocessor 305 may extract pattern recognition data. The pattern recognition data may be extracted using optical character recognition (OCR), computer vision, artificial intelligence, or other image processing techniques to recognize various patterns (e.g., text, trademarks, symbols, images, signals, etc.) in the images.

The extracted pattern recognition data may include textual data (e.g., character strings or text) found in regions of the image that correspond to signs, storefronts, or other markings. The pattern recognition module may also identify regions in the image that contain the textual data, calculate pixel data for the image (e.g., the number of pixels in each region containing the textual data, the total number of pixels in the image, the color of the pixels, etc.), or extract other data related to the images of geographical areas.

In one aspect, the pattern recognition module 310 may be able to generate pattern recognition data from multiple images of the same geographical area. For example, the imaging service may generate multiple images of a geographic area (e.g., images from different angles or locations). These images may share many commonalities. For example, each of the images of the geographic area may be associated with the identical location data or nearby location data, include the same character strings, or include similar image elements. The pattern recognition data may be generated based on the multiple images with shared commonalities.

The interface module 320 may be configured to receive data associated with an image of a geographical area that may be used to prioritize points of interest to be displayed in a map. For example, the interface module 320 may obtain pattern recognition data extracted from an image and location data for the image from an image preprocessor 305.

The search module 325 may be configured to search a listing database 340 for one or more point of interest listings that correspond with the pattern recognition data and the location data associated with the image. A point of interest listing may correspond if the pattern recognition data matches or closely matches one or more fields in the point of interest listing (e.g., a point of interest name) and the location data for the image is within a threshold distance of location coordinates for the point of interest listing.

If no corresponding point of interest is found, the search module 325 may discard the pattern recognition data and location data associated with the image and search the listing database 340 for point of interest listings using a new set of pattern recognition data and location data associated with another image.

If a corresponding point of interest listing is found, the priority module 330 may be configured to prioritize the point of interest listing. The corresponding point of interest listing may be prioritized by, for example, flagging the point of interest listing so that it my be included in maps. According to another aspect, the point of interest listing may be prioritized by increasing the ranking value for with the point of interest listing. The ranking value for the point of interest listing may then be used to determine whether to include the point of interest in a map.

The map module 335 may be configured generate a map to be displayed by, for example, identifying an area to be mapped, identifying point of interest listings located in the area to be mapped, and selecting a number of those point of interest listings to display based on the prioritization of each of the point of interest listings (e.g., a flag associated with one or more of the point of interest listings or the ranking value associated with the point of interest listings).

For example, if the point of interest listings are associated with a ranking value, the point of interest listings located in the area to be mapped that have a ranking value that exceeds a certain threshold may be designated for display. According to another aspect, only a predetermined number of point of interest listings with the highest ranking values may be designated for display. In yet another aspect, if a point of interest listing located in the area to be mapped is flagged by the priority module 330, the flagged point of interest listing may be designated by the map module 335 as one of the point of interest listings to be displayed regardless of ranking value.

Once the point of interest listings to be displayed are designated, the map module 335 may generate a map of the area that includes the designated point of interest listings. The interface module 320 may transmit the generated map to one or more requesting entities (e.g., a client machine) to be displayed on a user interface to a user. Further details for prioritizing points of interest for display in a map and generating the map are discussed further below.

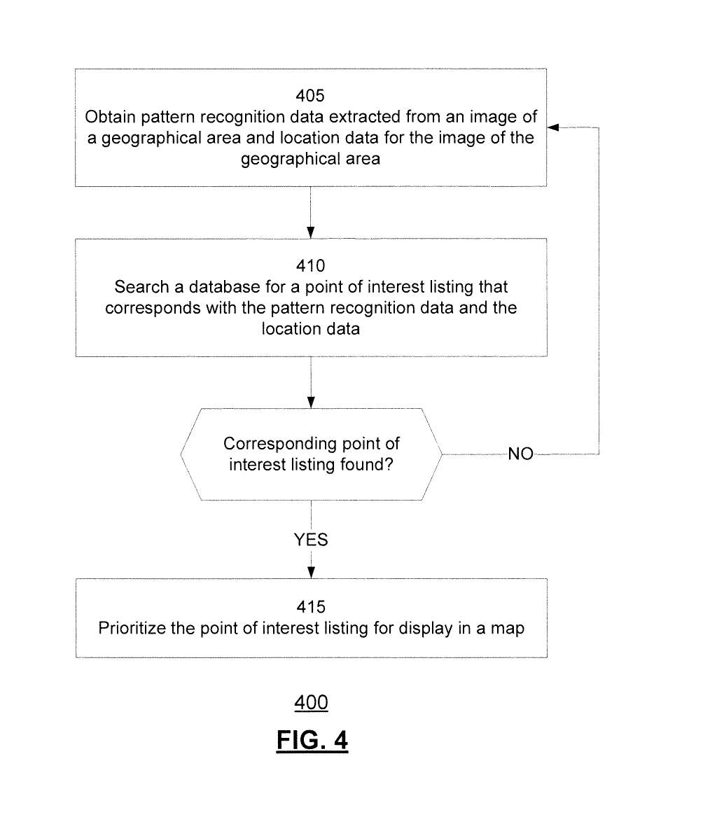

FIG. 4 is a flow chart illustrating a process 400 for prioritizing points of interest for display in a map, in accordance with various aspects of the subject technology. Although the operations in process 400 are shown in a particular order, certain operations may be performed in different orders or at the same time. In addition, although the process steps of FIG. 4 are described with reference to FIG. 3, the steps are not limited to being performed by the system of FIG. 3.

As discussed above, the process 400 may prioritize points of interest using one or more images of geographical areas. An image may be captured at an image source (e.g., a camera) and transmitted to an image preprocessor 305 along with location data for the location of where the image was taken.

The pattern recognition module 310 of the image preprocessor 305 may extract the pattern recognition data from at least one image of a geographical area obtained from an image source. The pattern recognition data may include character strings or text found in a region of the image (e.g., a sign or storefront captured in the image). In another aspect, the pattern recognition data may also include trademarks, symbols, or other markings and patterns that may be detected and used to identify points of interest in the images.

At operation 405, the interface module 320 may obtain the pattern recognition data extracted from the image and the location data for the image from the image preprocessor 305. The search module 325 may search a listing database 340 for a point of interest listing that corresponds with at least one of the pattern recognition data and the location data.

For example, the search module 325 may compare the pattern recognition data (e.g., a character string) with one of the fields in the point of interest listings (e.g., the name of the point of interest listing) and compare the location data for the image with location coordinates for the point of interest listing. The search module 325 may determine that the point of interest listing corresponds with the pattern recognition data and the location data associated with the image if the pattern recognition data matches one of the fields in a point of interest listing and the location data for the image matches or is within a predetermined distance (e.g., a threshold distance) from the location coordinates of the point of interest listing.

If no corresponding point of interest listing is found, the interface module 320 may obtain pattern recognition data and location data for another image and attempt to find a corresponding point of interest location for that image. On the other hand, if a corresponding point of interest listing is found, at operation 415, the priority module 330 may prioritize the corresponding point of interest listing.

For example, the priority module 330 may flag the point of interest listing that corresponds with the pattern recognition data and the location data for the image so that the map module 335 will be able to recognize the point of interest listing as one of the point of interest listings to be designated for display on a map. According to another aspect, however, prioritizing the point of interest listing may include increasing the ranking value associated with the point of interest listing. The ranking value may be increased by a predetermined amount or an amount calculated based on various factors associated with the point of interest listing.

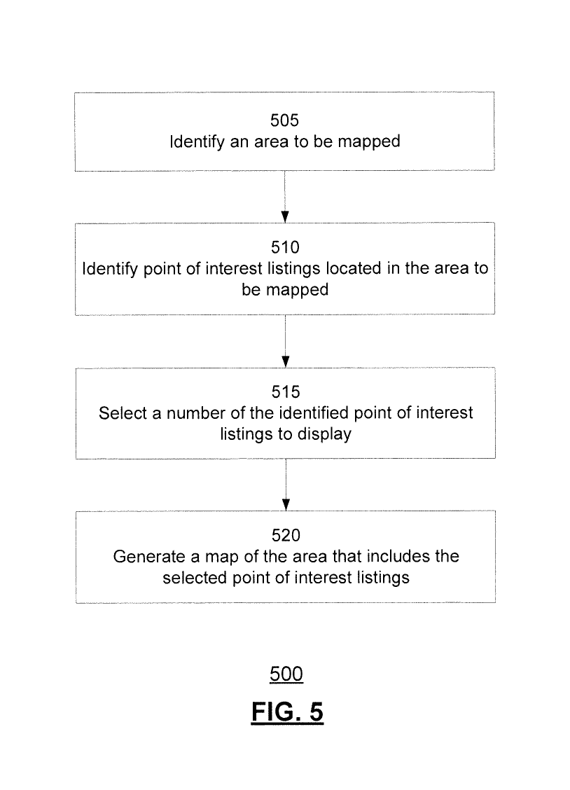

Using the process 400 in FIG. 4, the mapping system 315 may process pattern recognition data and location data for a number of images and prioritize a number of point of interest listings. These prioritized points of interest listings may then be used to determine which points of interest listings are to be displayed in a map. For example, FIG. 5 is a flow chart illustrating a process 500 for generating a map of an area that includes points of interest, in accordance with one of the subject technology.

At operation 505, the map module 335 may identify the area to be mapped. At operation 510, the map module 335 may identify points of interest listings located in the area to be mapped by searching the listing database 340 to find point of interest listings with location coordinates within the area to be mapped.

The map module 335 may select a number of identified point of interest listings in the area to be mapped to display in the map at operation 515. The map module 335 may select the points of interest listings based on flags associated with the point of interest listings that was set by the priority module 330 during process 400 of FIG. 4. The map module 335 may also select the points of interest listings based on ranking values associated with the point of interest listings. Once the points of interest listings are selected, the map module 335 may generate a map of the area that includes the selected point of interest listings at operation 520.

According to one aspect of the subject technology, the map module 335 may designate all point of interest listings flagged by the priority module 330 to be displayed regardless of ranking value. According to another aspect, the map module 335 may designate a predetermined number of point of interest listings with the highest ranking values for display. According to yet another aspect, the map module 335 may designate the point of interest listing for display in the map if the ranking value of the point of interest listing exceeds a predetermined threshold.

According to one aspect, the point of interest listing will be prioritized because the point of interest listing has been verified In other words, there is evidence that the location coordinates of the point of interest listing are correct based on the pattern recognition data for the image matching a field in the point of interest listing (e.g., the name of the point of interest listing) and the location data for the image being within a certain distance of the location coordinates of the point of interest listing.

For some applications (e.g., a routing service that gives users directions from one location to another), it may be helpful to users to display, on a map, point of interest listings that are more visible than others. According to one aspect, the priority module 330 may prioritize a point of interest listing for display in a map based the visibility of the point of interest. For example, the mapping system 315 may determine that a point of interest listing has a visible physical presence (e.g., a storefront or sign) if the search module 325 determines that the point of interest listing corresponds to the location data and pattern recognition data for an image. The priority module 330 may prioritize the point of interest listing (e.g., increase the ranking value for the point of interest listing) based on determining that the point of interest listing has a visible physical presence.

In some aspects, points of interests with more visible (e.g., larger) storefronts and signs may be prioritized more than points of interest with less visible storefronts and signs. For example, the image preprocessor 305 may be configured to determine the size (e.g., a size value) of a region in the image containing a character string (e.g., signage or a storefront in the image containing the name of a point of interest) and include a size value for the region in the image containing the character string in the pattern recognition data.

The pattern recognition data, including the size value for the region, may then be used by the priority module 330 to prioritize the point of interest listing in a manner described above. For example, those points of interest with larger signage may be flagged or have their ranking value increased more than points of interest with smaller signage.

The image preprocessor 305 may determine the size of a region using various methods. For example the size may be calculated based on the number of pixels in the image that are associated with the region or the size may be calculated based on an estimated distance from the location where the picture was taken to the signage as well as the number of pixels in the image associated with the signage. According to one aspect, the images generated by the imaging service may be standardized so that the sizes of regions in the images may be used in region area comparisons between images. Color, character string font, contrast, and other visibility factors may also be considered in prioritizing a point of interest listing for display.

According to another aspect of the subject technology, if a point of interest listing does not have a ranking value, the priority module 330 may be configured to calculate a ranking value for the point of interest listing based on one or more factors such as the physical presence of a point of interest listing, the distance of the point of interest to a reference location, the type of point of interest (e.g., a place business, a government office, a retail outlet, a landmark, business category, etc.), review ratings, the web presence of the point of interest, or other characteristics of the point of interest.

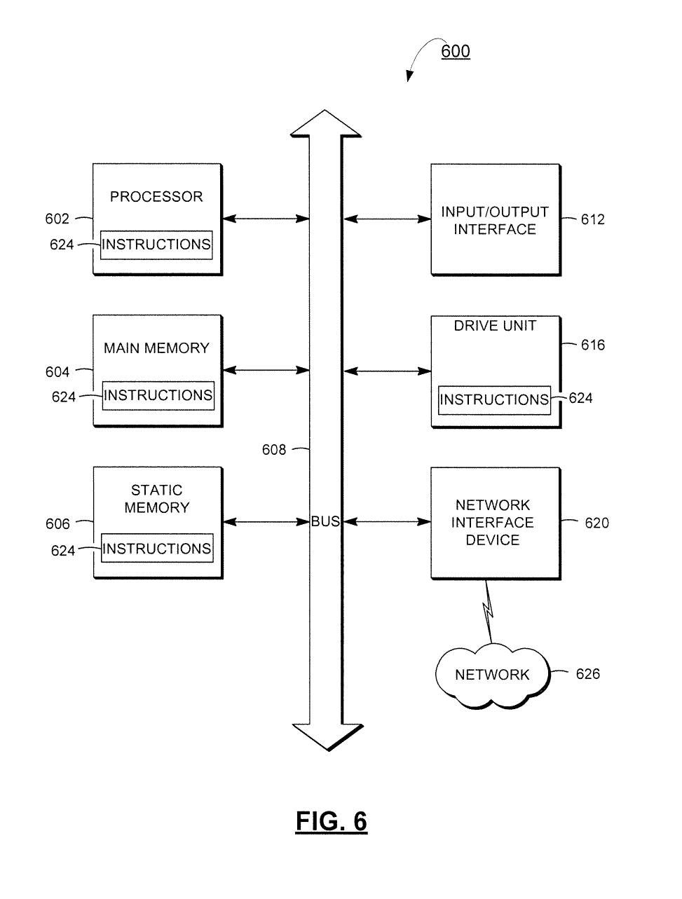

FIG. 6 is a block diagram illustrating a computer system with which any of the clients and servers of FIG. 1 may be implemented. In certain aspects, the computer system 600 may be implemented using hardware or a combination of software and hardware, either in a dedicated server, or integrated into another entity, or distributed across multiple entities.

The example computer system 600 includes a processor 602, a main memory 604, a static memory 606, a disk drive unit 616, and a network interface device 620 which communicate with each other via a bus 608. The computer system 600 may further include an input/output interface 612 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 602 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 624 embodying any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media. The instructions 624 may further be transmitted or received over a network 626 via the network interface device 620.

The machine-readable medium may be a single medium or multiple media (e.g., a centralized or distributed database, and/or associated caches and servers) that store one or more sets of instructions. The machine-readable medium may comprise the drive unit 616, the static memory 606, the main memory 604, the processor 602, an external memory connected to the input/output interface 612, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Systems, methods, and machine-readable media for prioritizing points of interest for display in a map have been described. In certain aspects a system may include an interface module, a search module, and a priority module. The interface module may be configured to obtain pattern recognition data and location data associated with an image of a geographical area. The search module may be configured to access a set of point of interest listings and determine whether the pattern recognition data and the location data associated with the image correspond with a point of interest listing in the set of point of interest listings. The priority module may be configured to prioritize the point of interest listing for display in a map if a point of interest listing in the set of point of interest listings is determined to correspond.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system.

Skilled artisans may implement the described functionality in varying ways for each particular application. For example, the modules may include software instructions encoded in a medium and executed by a processor, computer hardware components, or a combination of both. The modules may each include one or more processors or memories that are used to perform the functions described below. According to another aspect, the various systems and modules may share one or more processors or memories. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” may be used herein to mean “serving as an example or illustration.” Any aspect or design described herein as “exemplary” is not necessarily to be construed as All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A computer-implemented method for prioritizing points of interest for display in a map, the method comprising:
obtaining pattern recognition data extracted from an image of a geographical area, wherein the image is captured by a mobile device, and wherein the pattern recognition data is found in a region in the image;
obtaining location coordinates of the mobile device when the mobile device captured the image of the geographical area;
searching a database comprising a plurality of point of interest listings for a point of interest listing that corresponds with the pattern recognition data and the location coordinates; and
if the point of interest listing that corresponds with the pattern recognition data and the location coordinates is found:
determining a physical presence of the point of interest;
determining a size value associated with the region containing the pattern recognition data, wherein the size value is based on a distance from the location coordinates of the mobile device to the determined physical presence of the point of interest, and
prioritizing the point of interest listing for display in a map, wherein the point of interest listing is prioritized is based on the size value associated with the region containing the pattern recognition data.

2. The computer-implemented method of claim 1, wherein the pattern recognition data comprises optical character recognition (OCR) data that includes a character string.

3. The computer-implemented method of claim 1, wherein the point of interest corresponds with the pattern recognition data from the image and the location coordinates of the mobile device if:
the pattern recognition data matches a name in the point of interest listing; and
the location coordinates of the mobile device is within a threshold distance of location coordinates in the point of interest listing.

4. The computer-implemented method of claim 1, wherein the prioritizing of the point of interest listing for display in the map comprises setting a flag associated with the point of interest listing.

5. The computer-implemented method of claim 1, wherein the point of interest listing that corresponds with the pattern recognition data and the location coordinates comprises a ranking value, and wherein the prioritizing of the point of interest listing for display in the map comprises increasing the ranking value of the point of interest listing.

6. (canceled)

7. The computer-implemented method of claim 1, wherein the size value is calculated based on a number of pixels in the image that are associated with the region in the image.

8. The computer-implemented method of claim 5, further comprising:
identifying an area to be mapped;
identifying a plurality of point of interest listings located in the area to be mapped, wherein each point of interest listing in the plurality of point of interest listings comprises a ranking value;
selecting, from the plurality of point of interest listings, a set of point of interest listings to display in a map based on the ranking values for the plurality of point of interest listings; and
generating a map to be displayed on a user interface, the map including the set of point of interest listings.

9. The computer-implemented method of claim 8, wherein selecting the set of points of interest listings comprises:
ordering the plurality of point of interest listings based on the ranking values for the plurality of point of interest listings; and
selecting a number of point of interest listings based on the ordering.

10. The computer-implemented method of claim 8, wherein selecting the set of points of interest listings comprises selecting point of interest listings with ranking values above a threshold ranking value.

11. A system for prioritizing points of interest for display in a map, the system comprising:
an interface module configured to:
obtain pattern recognition data associated with an image of a geographical area, wherein the image is captured by a mobile device, and wherein the pattern recognition data is extracted from a region in the image, and
obtain location coordinates of the mobile device when the mobile device captured the image of the geographical area;
a search module configured to access a set of point of interest listings, determine whether the pattern recognition data associated with the image-and the location coordinates of the mobile device correspond with a point of interest listing in the set of point of interest listings, and determine a physical presence of the point of interest; and
a pattern recognition module configured to determine a size value associated with the region containing the pattern recognition data, wherein the size value is based on a distance from the location coordinates of the mobile device to the determined physical presence of the point of interest; and
a priority module configured to prioritize, based on the size value associated with the region containing the pattern recognition data, the point of interest listing for display in a map if a point of interest listing in the set of point of interest listings is determined to correspond.

12. The system of claim 11, wherein the pattern recognition data comprises optical character recognition (OCR) data that includes a character string.

13. The system of claim 11, wherein the search module is configured to determine whether the pattern recognition data and the location coordinates of the mobile device correspond to the point of interest listing by:
comparing the pattern recognition data with a name of the point of interest listing; and
comparing the location coordinates of the mobile device with location coordinates of the point of interest listing.

14. The system of claim 11, wherein each point of interest listing further comprises a ranking value, and
wherein the priority module is configured to prioritize the point of interest listing for display in the map by increasing the ranking value of the point of interest listing.

15. (canceled)

16. The system of claim 11, wherein the size value is determined based on a number of pixels in the image that are associated with the region.

17. The system of claim 11, wherein the priority module is configured to prioritize the point of interest listing for display in the map by setting a flag associated with the point of interest listing.

18. A non-transitory machine-readable medium comprising instructions stored therein, which when executed by a machine, cause the machine to perform operations comprising:
obtaining pattern recognition data extracted from an image of a geographical area, wherein the image is captured by a mobile device, and wherein the pattern recognition data is extracted from a region in the image;
obtaining location coordinates of the mobile device when the mobile device captured the image of the geographical area;
accessing a set of point of interest listings, wherein each point of interest listing in the set of point of interest listings comprises a ranking value;
searching the set of point of interest listings for a point of interest listing that corresponds with the pattern recognition data and the location coordinates;
determining a physical presence of the point of interest;
determining a size value associated with the region containing the pattern recognition data, wherein the size value is based on a distance from the location coordinates of the mobile device to the determined physical presence of the point of interest; and
modifying, if a corresponding point of interest listing is found, the ranking value of the corresponding point of interest listing based on the size value associated with the region containing the pattern recognition data.

19. The machine-readable medium of claim 18, wherein the pattern recognition data includes a character string.

20. The machine-readable medium of claim 18, wherein the modifying of the ranking value of the corresponding point of interest listing comprises increasing the ranking value of the corresponding point of interest listing.
